(19) United States
(12) Patent Application Publication
(10) Pub. No.: US 2003/0019705 A1
(43) Pub. Date: Jan. 30, 2003

(54) Luggage case with reinforcing structure

(76) Inventor: Boon Hwa Lau, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/910,777

(22) Filed: Jul. 24, 2001

(51) Int. Cl. B60B 33/04

(52) U.S. Cl. 190/18 A; 16/19

(57) ABSTRACT

The present invention relates a luggage case with reinforcing structure including a case body, four castors, four inner brackets, two pieces of the first tubes and two pieces of the second tubes, in which the inner bracket, the first tube and the second tube are joined together to reinforce the structural strength, capable of bearing heavier load. The luggage case so reinforcing still keeps the originally neat and good looking and maintains the storage capacity with no space reduced.

### FIELD OF THE INVENTION

The present invention relates to a luggage case with reinforcing structure to gain a better strength. The reinforcing structure is hidden internally, so its original neat and good-looking appearance is not sacrificed at the expense of storage capacity.

### BACKGROUND OF THE INVENTION

The FIG. 1 shows a prior art of the luggage case 1a, which is composed of a case body 10a to store personal effects. It further includes at least two castors 11a outfitted on the bottom of the case body 10a. a handle bar 12a and two extension rods 13a mounted on the back of the case body 10a, which constitute the extension rod mechanism for the carrier to pull off the extension rods 13a and to easily move the luggage case on the castors 11a.

As shown in FIG. 2, conventionally, the case body (or bag) 10a of the luggage case 1a is made of a thin plastic material (such as PE plate), which makes it hard for the bottom of the luggage case to bear heavy load, so it is easily subject to deformation. In general practice, the bottom of the body case 10a is reinforced with a stiffening plate 14a, which is made of honeycomb board or plywood board in an effort to stand more load without deformation.

However, when adding a stiffening plate 14a to the conventional luggage case 1a, the storage capacity of the case body 10a would be inevitably sacrificed. In particular, the stiffening plate of honeycomb or plywood board has a limited strength to bear heavy load, so the luggage case la is easily subject to deformation. Instead, the stiffening plate 14a added in this manner would shorten the service life of the luggage case 1a considerably.

### SUMMARY OF THE INVENTION

The primary object of the present invention is to provide a luggage case with reinforcing structure to gain a better strength, so it would be capable of bearing heavier load with no worry of deformation. The good-looking design is still maintained and the stiffened structure would render the luggage case longer service life.

Another object of the invention is provide a reinforcing structure for the luggage which is hidden internally, so the original good-looking design is kept and the stiffened structure would not occupy the space the storage capacity permits.

To achieve the aforesaid objects, the luggage case with reinforcing structure provided in the invention comprises a case body, four castors, four inner brackets, two pieces of first tubes and two pieces of second tubes. The castors correspondingly pivotally connected to the casings respectively fixed to each of four corners in a bottom of the case body. The inner brackets mounted on a top of each of the casings. The first tubes and the second tubes respectively having two ends respectively inserted in each of the inner brackets. Such linkage would work as reinforcing structural.

The drawings disclose the illustrative embodiments, which serve to exemplify various advantages and objects hereof but impose no limitation thereon.

### BRIEF DESCRIPTION OF THE DRAWINGS

FIG. 1 is a stereo appearance of the prior art of the luggage case FIG. 2 is a section view of reinforcing structure of the prior art of the luggage case FIG. 3 is a stereo disassembly of the luggage case of the invention. FIG. 4 is a section of the luggage case of the invention

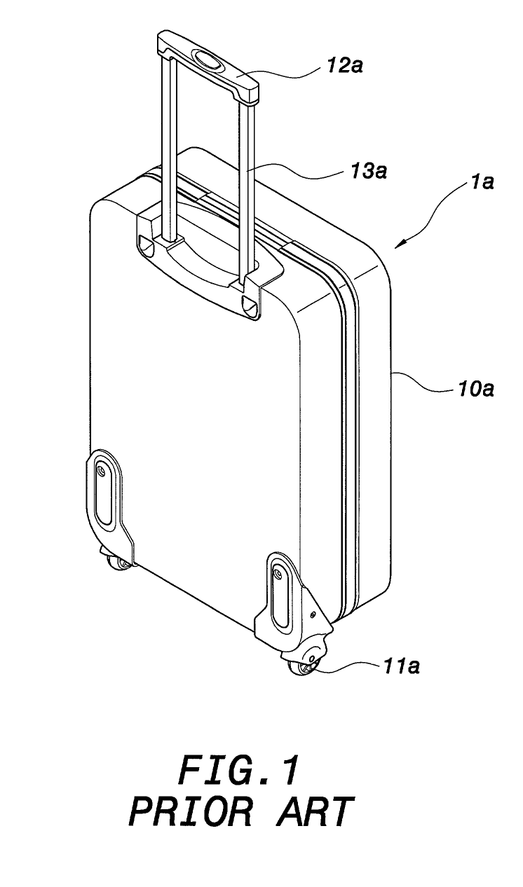

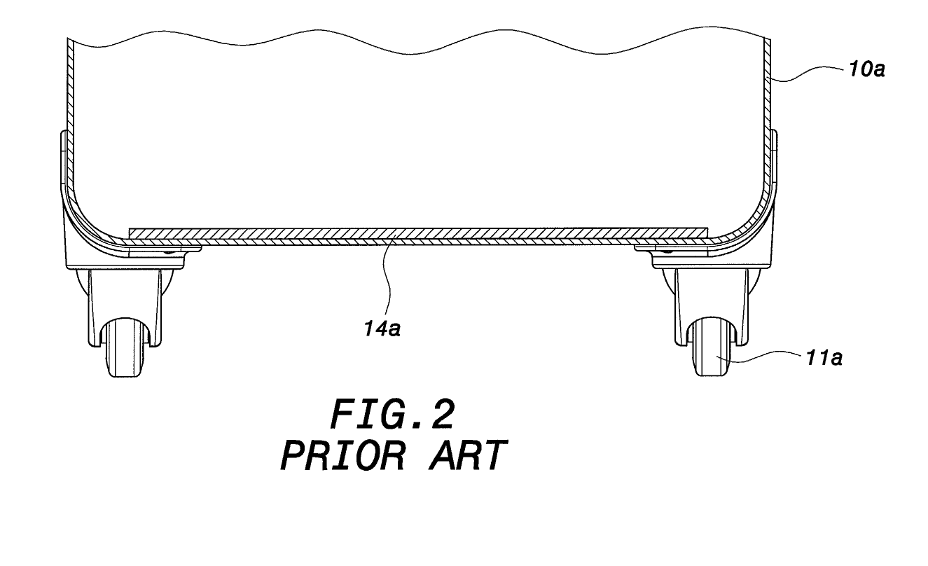

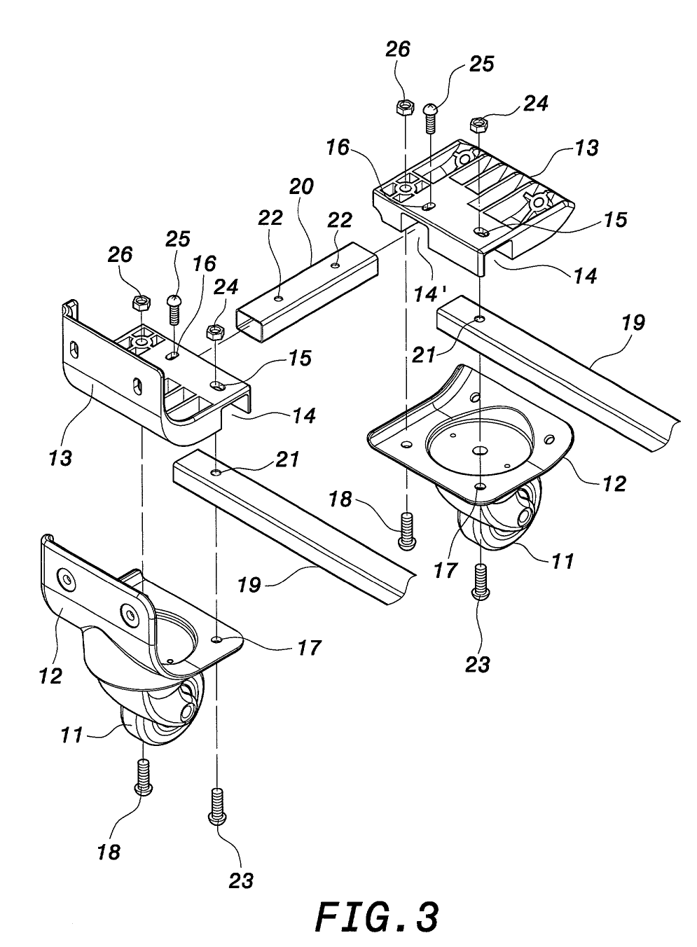

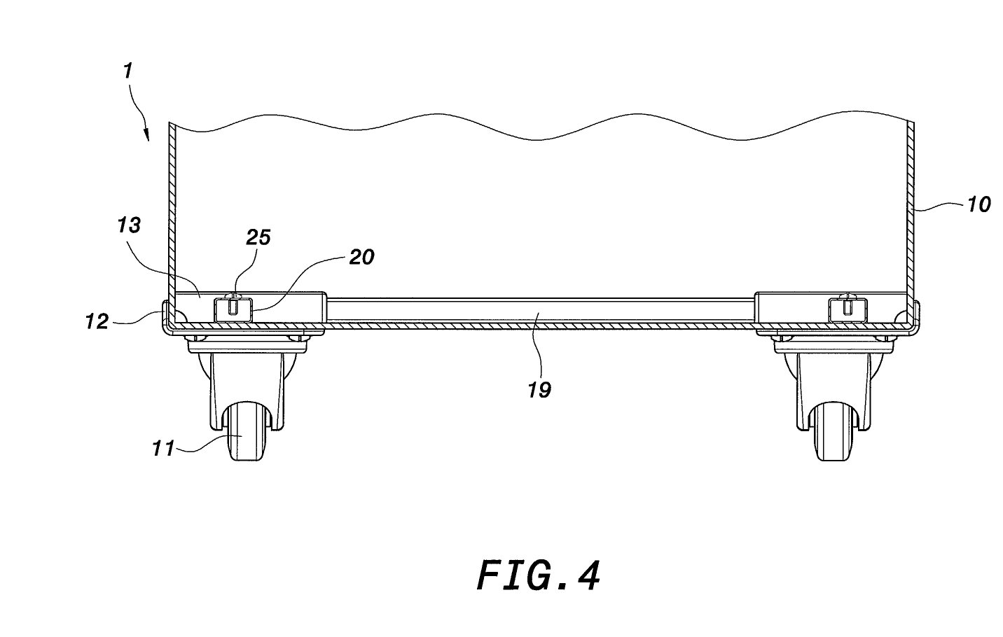

### DETAILED DESCRIPTION OF THE INVENTION

FIGS. 3 and 4 show the luggage case with reinforcing structure of the invention, in particular, an improved reinforcing structure mounted on the bottom of the case body. The luggage case 1 comprises a case body 10 for storing personal effects. The case body 10 contains four castors 11, with an extension rod mechanism (no shown) installed on the back of the case body 10. The carrier can pull out the extension rod and tow the luggage case along the castors 11 to easily move the luggage case on the ground.

Each castor 11 is pivotally connected to a castor casing 12. The casing 12 for the front side and the rear side of the casters 11 are of different forms. The caster 11 is free to rotate inside the casing 12. The casing 12 is fastened to the bottom of the case body 10 by bolts or rivets.

The top of the casing 12 will receive an inner bracket 13. The profile of the inner bracket 13 is similar to that of the casing 12. On the bottom of the inner bracket 13, there are openings to form the first recess 14 and the second recess 14′. The inner bracket 13 is drilled with two upper bolt holes 15 and 16 responding to the bolt hole 17 on the casing 12.

Among the inner rackets 13, there are two pieces of a first tube 19 respectively installed on front or rear and two pieces of a second tube 20 respectively installed on left and right. The section size of the first tubes 19 couple with the first recess 14 and the section size of the second tubes 20 couple with the second recess 14′.

The ends of two pieces of first tubes 19 and two pieces of second tubes 20 are drilled with link holes 21 and 22 respectively. The link holes 21 of the first tube 19 corresponds to the upper bolt hole 15 of the inner bracket 13 and the under bolt hole 17 of the casing 12. The link hole 22 on the ends of the second tubes 20 corresponds to the upper bolt hole 16 on the inner bracket 13.

The ends of the first tube 19 are inserted into the recess 14 of the inner bracket 13 and sandwiched between the casing 12 and the inner bracket 13. A bolt 23 passes through the under bolt hole 17 on the casing 12, the link hole 21 on the first tube 19 and the upper bolt hole 15 on the inner bracket 13 and is locked in place by a nut 24 to unite the casing 12 and the inner bracket 13 integrally. Two ends of the first tube 19 are inserted into two inner brackets 13, which stand apart and in opposite directions. A bolt 18 and a nut 26 lock the casing 12 the first tubes 19, the second tubes 20 and the inner bracket 13 together.

In a similar way, the ends of the second tube 20 are inserted into the recesses 14′ of the inner bracket 13 and sandwiched between the casing 12 and the inner racket 13. A bolt 25 passes through the upper bolt hole 16 of the inner bracket 13 and the link hole 22 of the second tube 20 to lock them together. Two ends of the second tube 20 will be held between the front and rear inner brackets 13. This combination forms a luggage case with reinforcing structure.

The linkage of the inner bracket 13 with the first tube 19 and the second tube 20, act as a reinforcing structure permitting the case body 10 to bear heavier load without deformation.

The luggage case with reinforcing structure is hidden internally; the appearance originally designed for the luggage case remains unchanged. The conventional way to reinforce the luggage case with a reinforcing plate placed on the bottom occupies considerable space of the storage capacity and is thus undesirable.

The first tube 19 and the second tube 20 of the invention can be made of steel or metal material to enhance the strength, so it will be possible to bear heavier load. The good-looking is maintained and the service life is extended.

The invention is in reality eliminated the defects the conventionally stiffened plate cherishes, such as limited strength, occupation of storage space and deformation. The product described in the invention is a novel, creative and advanced design, complying fully with the patent requirements and is justified for a grand of patent certificate.

Many changes and modifications in the above-disclosed embodiment of the invention can, of course, be carried out without departing from the scope thereof. Accordingly, to promote the progress in science and the useful arts, the invention is disclosed and intended to be limited only by the scope of the appended claims.

What is claimed is:

1. A luggage case with reinforcing structure, comprising:
a case body;
four castors pivotally connected to casings respectively fixed to each of four comers in a bottom of the case body;
four inner brackets mounted on a top of each of the casings; and
two pieces of first tubes and two pieces of second tubes, each having two ends respectively inserted in each of the inner brackets.

2. The luggage case with reinforcing structure of claim 1, wherein each of the inner brackets has a first recess, a second recess and upper bolt holes, each of the casings has under bolt holes; the ends of each of the first tubes and the second tubes respectively have link holes, that are inserted in the first recess and the second recess of each of the inner brackets and that are sandwiched between each of the casings and the inner brackets; a plurality of bolts respectively are passed through each of the upper bolt holes, the under bolt holes and the link holes, whereby to fix the casings, the first tubes, the second tubes and the inner brackets by nuts.
